(19) United States
(12) Patent Application Publication
(10) Pub. No.: US 2019/0288460 A1
(43) Pub. Date: Sep. 19, 2019

(54) PLUG

(71) Applicant: Feller GmbH, Günselsdorf (AT)

(72) Inventors: Walter Hammer, Sollenau (AT); DIETMAR BRANDSTÄTTER, Markt Piesting (AT); ANDREAS RENNER, Ternitz (AT)

(73) Assignee: Feller GmbH, Günselsdorf (AT)

(21) Appl. No.: 16/355,388

(22) Filed: Mar. 15, 2019

(30) Foreign Application Priority Data
Mar. 16, 2018 (AT) A 50226/2018

(51) Int. Cl. H01R 13/66; H01R 13/504; H01R 43/20; H01R 24/28

(52) U.S. Cl. CPC H01R 13/6683; H01R 13/504; H01R 2103/00; H01R 24/28; H01R 43/20

(57) ABSTRACT

A plug includes a carrier plate and at least two contact pins which are affixed on the carrier plate. The contact pins each have a free end and a terminal end and electrical conductors of a cable and are connected to the terminal ends. An insert having a partition wall is affixed on the carrier plate. The insert has a receptacle which is disposed on a side the partition wall facing away from the contact pins. A temperature sensor is arranged in the receptacle.

### CROSS-REFERENCES TO RELATED APPLICATIONS

This application claims the priority of Austrian Patent Application, Serial No. A 50226/2018, filed Mar. 16, 2018, pursuant to 35 U.S.C. 119(a)-(d), the content of which is incorporated herein by reference in its entirety as if fully set forth herein.

### BACKGROUND OF THE INVENTION

The present invention relates to a plug to connect a high-power device to a low-voltage grid.

The following discussion of related art is provided to assist the reader in understanding the advantages of the invention, and is not to be construed as an admission that this related art is prior art to this invention.

Plugs which are intended to connect high-power devices, for example chargers for electric vehicles, to a low-voltage grid are known. Demand for such plugs is increasing due to the growing popularity of electric mobility and the need for charging electric vehicles at home with a charger that can be connected to the household network. Due to the high power input for a low-voltage network, heat can be generated at the plug during charging. This heat generation can be monitored with temperature sensors, so that the charging current can be reduced in the event of excessive heat generation to prevent damage to the plug, which may cause electric accidents or a fire. The integration of temperature sensors in a plug is associated with stringent regulatory requirements for safety reasons. On the one hand, it must be ensured that the circuit with the mains voltage and the sensor circuit having a supply voltage that is only a small fraction of the mains voltage are reliably electrically separated from each other. This can be accomplished, for example, by using electrically insulating shrink tubing, with which the sensor circuit is isolated with respect to the circuit with the mains voltage. Furthermore, good thermal contact between the contact pins and the temperature sensors is required in order to be able to detect a temperature increase sufficiently fast.

Disadvantageously, such plugs are very expensive to manufacture, and many manufacturing steps must be performed manually. For example, the isolation of the sensor circuit with shrink tubing is very labor intensive and therefore very expensive in mass production. Furthermore, it must be emphasized during production that small defects can entail a serious potential risk. For example, it must be ensured during production that no individual strands are exposed, when the electrical conductors are connected to the contact pins, which could come into contact with the sensor circuit or reduce breakdown voltages.

It would therefore be desirable and advantageous to obviate prior art shortcomings and to provide an improved plug which allows reliable and electrically safe monitoring of the temperature of the plug at high currents, and which can still be manufactured easily and in high quantities.

### SUMMARY OF THE INVENTION

According to one aspect of the present invention, a plug has a carrier plate and at least two contact pins affixed to the carrier plate. The contact pins each have a free end and a terminal end, to which electrical conductors of a cable are connected. An insert with a partition wall is affixed on the carrier plate, with the insert having at least one receptacle on a side of the partition wall facing away from the contact pins. A temperature sensor is arranged in the at least one receptacle.

Advantageously, critical heat generation at the plug can thus be reliably measured, wherein the plug provides high electrical safety by a possible separation of the two circuits, but can still be readily manufactured in large quantities. The circuits with the grid voltage and the supply voltage are in this case electrically insulated from each other by the partition wall over a large surface area, even when they are located in close proximity to each other. This obviates the need for reliably insulating of the electric circuit of the temperature sensor, which can then be manufactured more cost-effectively. The insert with the partition wall and the at least one receptacle in which the temperature sensor is arranged can hereby be assembled and prefabricated separately from the carrier plate, and thereafter be affixed to the carrier plate. This allows a high degree of automation in the production process. Furthermore, the part of the plug with the carrier plate, the pins and the electrical wires can be produced with the temperature sensor largely independently from the insert, and also does not require subsequent manipulation, so that production of a connector with temperature sensors can be switched quickly to a production of a plug without temperature sensors. The arrangement of the temperature sensor in the at least one receptacle of the insert provides good thermal contact between the insert and the partition wall and the temperature sensor, since the insert has a large thermal contact surface to the contact pins and the electrical conductors by virtue of the partition wall, thereby guaranteeing good overall thermal connection of the temperature sensor. The temperature sensor also is securely positioned by arranging the temperature sensor in the at least one receptacle.

According to another aspect of the present invention, a method for producing a plug affixing at least two contact pins on a carrier plate, connecting electrical conductors of a cable to terminal ends of the at least two contact pins, arranging a temperature sensor in a receptacle on one side in a partition wall of an insert which side faces away from the contact pins, and affixing the insert on the carrier plate.

In this way, the plug can be readily manufactured in large quantities, whereby the temperature of the plug at high currents can be reliably and in an electrically safe manner monitored.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a front view of a first embodiment of a plug according to the present invention before injection-overmolding;

FIG. 2 shows a side view of the plug before injection-overmolding;

FIG. 3 shows a plan view of the plug before injection-overmolding;

FIG. 4 shows a front view of the injection-overmolded plug;

FIG. 5 shows a side view of the injection-overmolded plug;

FIG. 6 shows a view obliquely from below of an insert and a temperature sensor of the plug in a first state;

FIG. 7 shows a view obliquely from below of the insert and the temperature sensor of the plug in a second state;

FIG. 8 shows a view obliquely from below of the insert and the temperature sensor of the plug in a third state;

FIG. 9 a view obliquely from above of the insert and the temperature sensor of the plug in the third state;

FIG. 10 shows a plan view of the insert and the temperature sensor of the plug in the third state;

FIG. 11 shows a perspective view of an arrangement of temperature sensors in relation to plug contacts of the plug;

FIG. 12 shows a view obliquely from above of an insert and a temperature sensor of a second embodiment of a plug according to the present invention in a third state; and

FIG. 13 shows a view obliquely from above of the plug of FIG. 12 before injection-overmolding.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

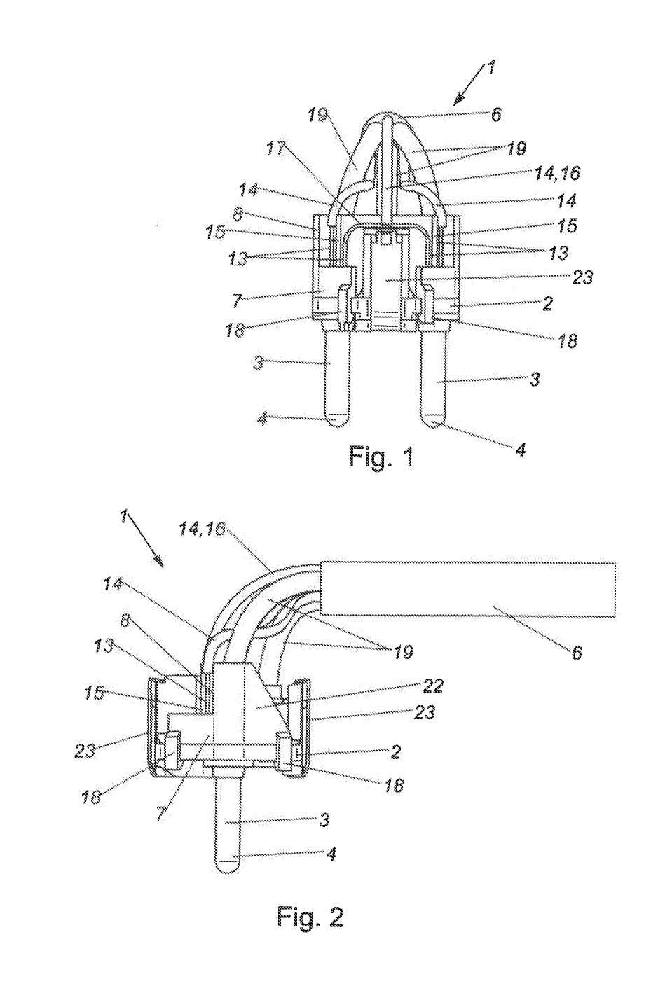

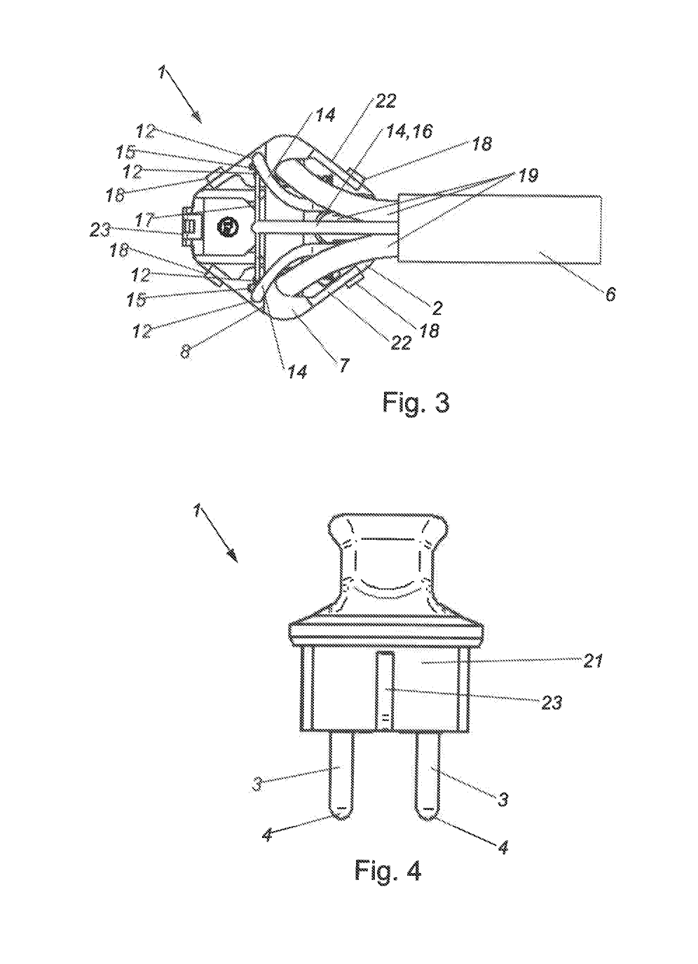

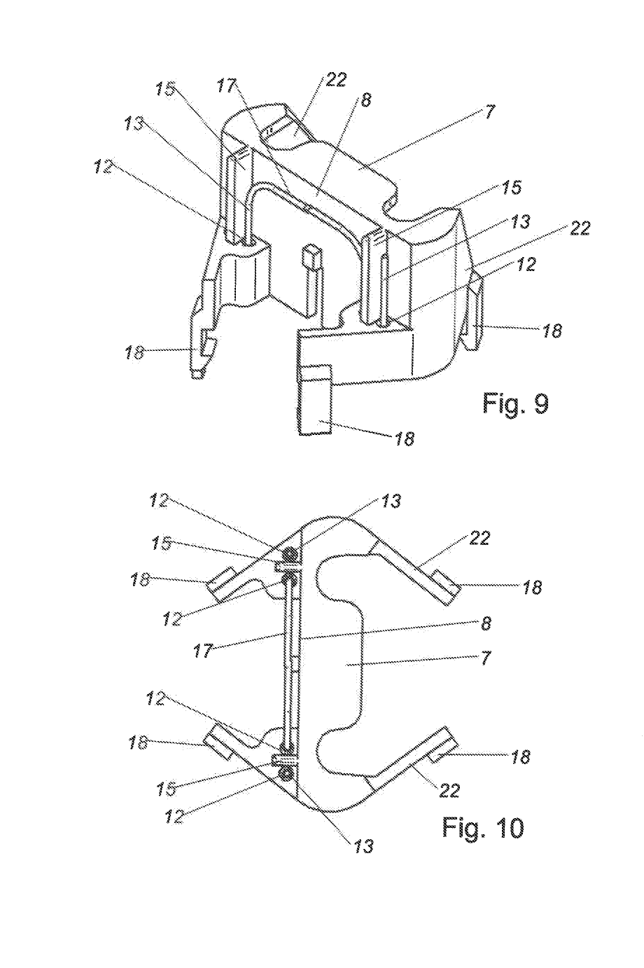

Turning now to the drawing, FIGS. 1 to 13 show at least parts of preferred embodiments of a plug 1, with a carrier plate 2 and at least two contact pins 3 affixed on the carrier plate 2, wherein the contact pins 3 each have a free end 4 and a terminal end 5, wherein electrical conductors 19 of a cable 6 are connected to the terminal ends 5 of the contact pins 3.

The plug 1 is designed particularly for use with a charger for charging an electric vehicle. Furthermore, a charger is provided for charging an electric vehicle with the plug 1. The plug 1 can advantageously also be used with other devices, in particular devices where heat generation in the plug 1 is to be expected.

The plug 1 is in particular a plug-in device. Furthermore, the plug 1 is designed in particular as a power plug for a low-voltage network of 110 V to 250 V. The plug 1 may in particular be a plug 1 for lighting applications and thus have only a single pin 3 for a hot conductor. The plug 1 may be in particular a 3-pin connector. Such plugs for lighting current are designed for lower power than plugs 1 for high current. Advantageously, the plug 1 may be a shockproof (Schuko) plug, or a standardized plug comparable to a Schuko plug, such as a type B plug or a type G plug. Sockets for such plugs 1 are essentially installed in every household, so that the charger can be plugged in almost anywhere.

The plug 1 has a carrier plate 2, on which the contact pins 3 are affixed, in particular fed through. The carrier plate 2 may be made of an insulating material, in particular plastic. The free ends 4 of the contact pins 3 are configured for insertion into a socket. Here, a first side of the carrier plate 2 may face the free ends 4. The terminal ends 5 may be arranged on a second side of the carrier plate 2 facing away from the first side of the carrier plate 2 or inside the carrier plate 2.

The terminal ends 5 are connected to electrical conductors 19, which are combined in a cable 6. The connection of the terminal ends 5 with electrical conductors 19 can be implemented in particular by way of a crimp connection. In this case, a first electrical conductor 19 may be formed as a hot conductor, and a second electrical conductor 19 as a neutral conductor. Furthermore, an electrical conductor 19 formed as a protective conductor may be connected with lateral contact surfaces 23.

An insert 7 is attached to a partition wall 8 on the carrier plate 2, with the insert 7 having at least one receptacle 9 on the side of the partition wall 8 facing away from the contact pins 3, wherein a temperature sensor 10 is arranged in the at least one receptacle 9.

The insert 7 is an electrically insulating part, preferably made of plastic, which is installed in the plug 1 by attaching it to the carrier plate 2. The insert 7 is advantageously formed as one piece, which substantially simplifies its attachment to the carrier plate 2.

The insert 7 has a partition wall 8, which separates a first inner region of the plug 1 with the electrical conductors 19 of the contact pins 3 from a second inner region of the plug 1 with the temperature sensors 10 and the sensor lines 14. When the molded part 7 is installed, the partition wall 8 bears against the carrier plate 2, in particular against the first side of the carrier plate 2 facing away from the free ends 4 and extends away from the carrier plate 2.

The insert further has at least one receptacle 9, in which a temperature sensor 10 is arranged. The receptacle 9 is preferably formed directly on the partition wall 8. The receptacle 9 is furthermore preferably arranged on a region of the partition wall 8 which directly faces a terminal end 5. The receptacle 9 preferably has a profile which corresponds to a profile of the temperature sensor 10. Furthermore, the receptacle 9 may completely enclose the temperature sensor 10, in particular at least in a circular fashion.

The temperature sensor 10 serves to measure a temperature inside the plug 1, preferably at the terminal ends 5 of the contact pins 3. The temperature sensor 10 may particularly preferably be a NTC sensor, alternatively also a PTC sensor or another sensor type. Advantageously each contact pin 3 may have its own temperature sensor 10. The temperature sensor 10 is connected to sensor leads 14, which may in particular also be carried by the cable 6. The sensor leads 14 may be connectable at another end of the cable 6 to a temperature controller. In particular, parts of the electrical circuit of the temperature sensor 10 may only be partially isolated up to a height of the partition wall 8, which makes manufacture of this circuit easier.

Furthermore, in a method for producing the plug 1, wherein at least two contact pins 3 are affixed to the carrier plate 2, wherein the electrical conductors 19 of the cable 6 are connected to the terminal ends 5 of the contact pins 3, a temperature sensor 10 is arranged in the at least one receptacle 9 of an insert 7, wherein the insert 7 has a partition wall 8 and the at least one receptacle 9 is arranged on a side of the partition wall 8 facing away from the contact pins 3, and the insert 6 is affixed to the carrier plate 2.

This has the advantage that critical heat generation of the plug 1 can be reliably measured, with the plug 1 providing a high level of electrical safety with respect to the separation of the two circuits, while still being easily producible in large numbers. In this case, the circuits with the mains voltage and the supply voltage are reliably electrically insulated from each other by the partition wall 8 over a large surface area, even when they are spatially close to each other. This eliminates the need for reliable insulation of the circuit of the temperature sensor 10, which can thus be manufactured with less complexity. The insert 7 with the partition wall 8 and the at least one receptacle 9, in which the temperature sensor 10 is arranged, can hence initially be pre-mounted and assembled separately from the carrier plate 2 and selected be prefabricated, and thereafter be connected to the carrier plate 2. This enables a high degree of automation of the production. Furthermore, the part of the plug 1 with the carrier plate 2, the pins 3 and the electrical conductors 19 can be manufactured largely independent of the insert 7 with the temperature sensor 10, and also requires no additional manipulation afterwards, so that production of a plug 1 with temperature sensors 10 can be quickly converted to production of a connector 1 without temperature sensors 10. The arrangement of the temperature sensor 10 in the at least one receptacle 9 of the insert 7 provides good thermal contact between the insert 7 with the partition wall 8 and the temperature sensor 10, because the insert 7 has by virtue of the partition wall 8 a large heat transfer surface to the contact pins 3 and the electrical conductors 19, thereby ensuring overall good thermal contact of the temperature sensor 10. The position of the temperature sensor 10 is also reliably secured due to its placement in the at least one receptacle 9.

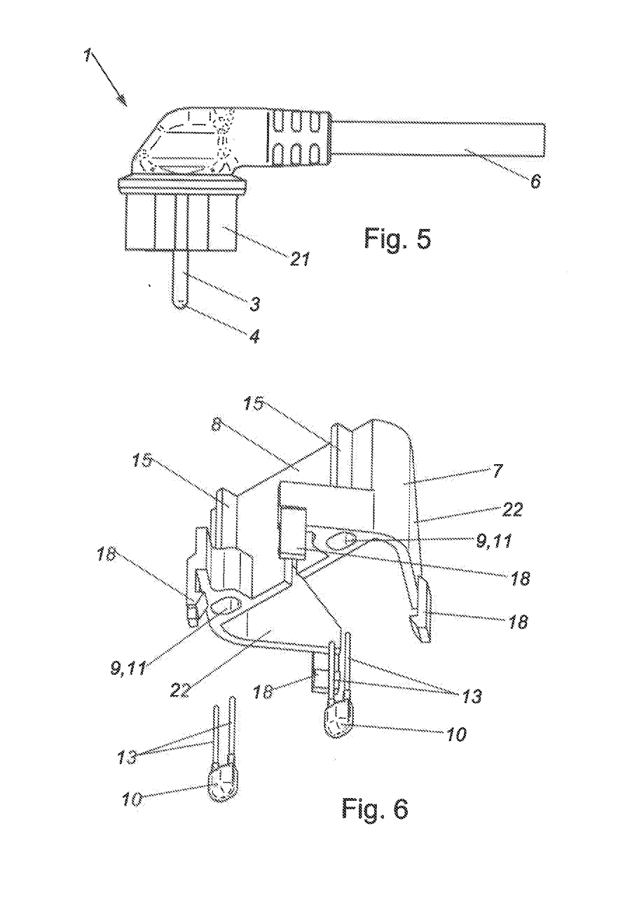

Advantageously, the plug 1 may have an injection-overmolded casing 21. In this case, the plug 1 is provided, in a state shown in FIGS. 1 to 3 and 13 for producing the finished plug 1, with an injection-molded casing 21 which surrounds the carrier plate 2 and the insert 7. FIGS. 4 and 5 show the plug 1 in a finished state. The insert 7 is completely surrounded by the injection-molded casing 21. The injection-molded casing 21 provides a frequently employed and cost-effective method for producing a housing for the plug 1. Alternatively, however, a housing may also be manufactured from a hard shell.

The partition wall 8 preferably has a width that extends substantially over the entire width of the carrier plate 2.

The height of the partition wall 8 preferably extends beyond the height of the lateral contact surfaces 23.

A thickness of the partition wall 8 may be at most 2 mm, preferably at most 1 mm, particularly preferably at most 0.5 mm.

Advantageously, the temperature sensor 10 may be in thermal contact with an inner wall of the at least one receptacle 9 by way of an interference fit. An interference fit ensures good and uniform thermal contact between the temperature sensor 10 and the insert 7, without running the risk that the thermal contact is unpredictably decreased by air inclusions. Furthermore, the production is particularly simple, since the temperature sensor 10 only needs to be pressed with a sufficient force into the at least one receptacle 9.

In particular, an insertion opening 11 of the at least one receptacle 9 for the temperature sensor 10 may be arranged on a side of the insert 7 facing the carrier plate 2, with the insertion opening 11 being closed off by the carrier plate 2. In the method, the temperature sensor 10 may be inserted into the at least one receptacle 9 through the insertion opening 11, and the insertion opening 11 may be closed off by the carrier plate 2 when the insert 7 is affixed on the carrier plate 2. Therefore, the insertion opening 11 for the temperature sensor 10 is automatically closed off when the insert 7 is affixed on the carrier plate 2, thereby preventing the temperature sensor 10 from exiting the receptacle 9.

Advantageously, the temperature sensor 10 has two parallel contact pins 13, which can be used to connect the temperature sensor 10 to the electrical sensor circuit.

The contact pins 13 may in particular extend parallel to the partition wall 8.

Advantageously, exit openings 12 for two electric contact pins 13 of the temperature sensor 10 and a stop for the temperature sensor 10 may further be arranged on a side of the at least one receptacle 9 facing away from the inlet opening 11. In particular, a separate exit opening 12 may be provided for each contact pin 13, whereby the area between the two exit openings 12 is formed as a stop for the temperature sensor 10 in the at least one receptacle 9. As a result, the contact pins 13 are located at well-defined positions, thus simplifying further connection of the contact pins 13 with the remaining circuit of the temperature sensor.

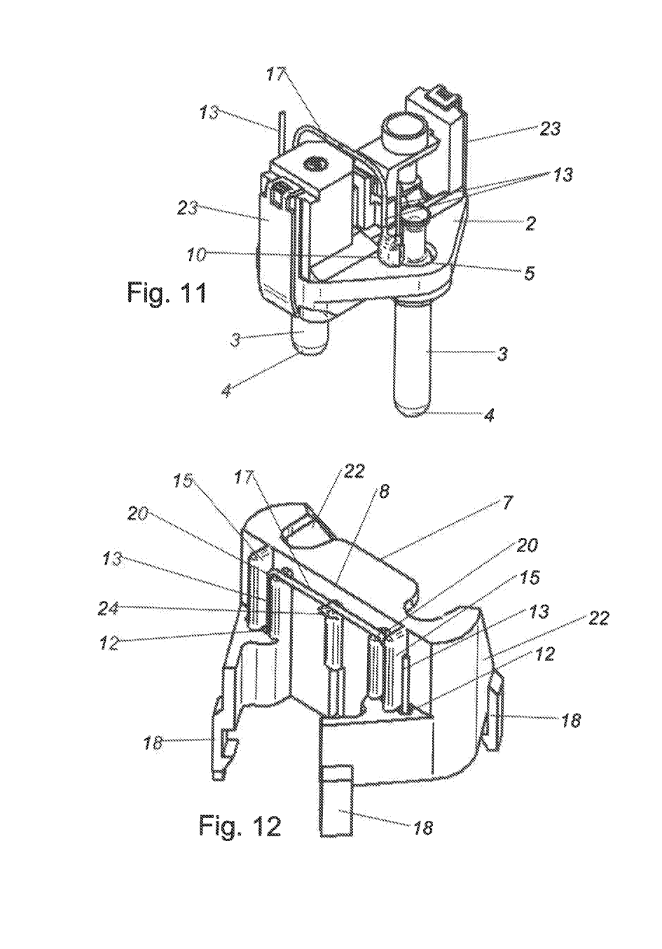

In particular, an associated receptacle 9 with a temperature sensor 10 may be provided for each pin 3. In the case of two pins 3, two receptacles 9, each with a temperature sensor 10 may therefore be provided. FIG. 11 shows the temperature sensor 10 in relation to the contact pins 3, wherein the insert 7 is hidden for better visibility.

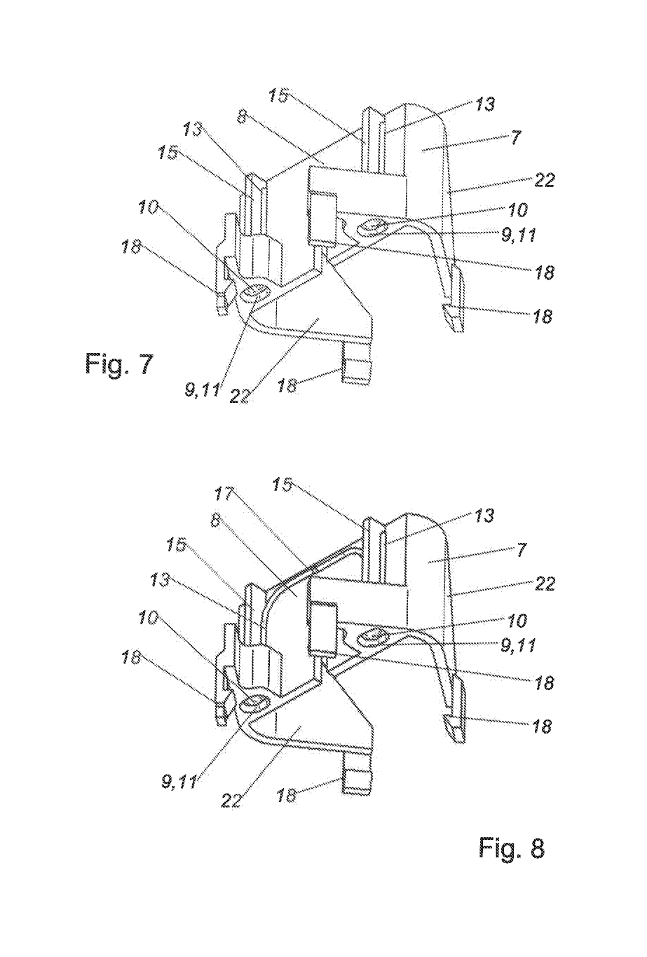

FIG. 6 shows the insert 7 in a state in which the temperature sensors 10 are still arranged outside the recesses 9. In FIG. 7, the temperature sensors 10 are then disposed within the recesses.

Advantageously, a sensor neutral conductor 16 may be connected to a conductor bracket 17, with the conductor bracket 17 electrically connected to at least two temperature sensors 10. The sensor neutral conductor 16 connects a ground potential with the temperature sensors 10. When the temperature sensor 10 is operated with direct current, the sensor neutral conductor 16 can be regarded as ground. In particular, the conductor bracket 17 may be uninsulated, so that the sensor neutral conductor 16 can simply be connected thereto. Due to its bracket shape, the conductor bracket 17 can be routed past the lateral contact surfaces 23 by way of the attachments.

The conductor bracket 17 can be prepared in particular by angling and then connecting a respective contact pin 13 of two temperature sensors 10. Alternatively, the conductor bracket 17 may be formed by an additional conductor connected to respective contact pins 13 of at least two temperature sensors 10.

FIGS. 8, 9 and 12 show the insert 7 in a state in which the conductor bracket 17 was formed. In this state, the insert 7 is preferably attached to the carrier plate.

Advantageously, the insert 7 may be fastened to the carrier plate 2 by a clip connection 18.

On the partition wall 8, in particular, two side regions 22 may extend around the first inner region of the plug 1 with the electrical conductors 19 and the contact pins 3, wherein the partition wall 8 with the two side regions 22 forms a substantially U-shaped boundary that is open at the edge. This can prevent a free strand of an electrical conductor 19 from projecting around the dividing wall 8 into the first interior region of the plug 1 having the temperature sensors 10. Furthermore, this makes the insert 7 more stable and reduces the risk that the insert 7 is displaced during the injection of the injection-molded casing 21. Two clip connectors of the clip connection 18 can in particular be arranged at free ends of the side regions 22.

Moreover, clip connectors of the clip connection 18 may be formed on the projections formed on the recesses.

Advantageously, the insert 7 has an open-edge design with respect to a first inner region of the plug 1 with the electrical conductors 19 of the contact pins 3, so that the insert 7 can be attached to the carrier plate during manufacture of the plug 1, when the electrical conductors 19 are already connected with the contact pins 3. As a result, the typical manufacturing steps for a plug 1 without a temperature sensor 10 can be retained.

In particular, an extension 15 may be formed between two sensor lines 14 connected to the temperature sensor 10 arranged on the partition wall 8 at the at least one receptacle 9. In particular, an extension 15 can be formed at each receptacle. The extension 15 may in particular extend from the receptacle 9 to an upper end of the partition wall 8. The extension 15 reliably separates the two contact pins 13 of a temperature sensor 10 from each other, thus eliminating the risk that a contact pin 13 is pressed against another contact pin 13, when the injection-molded casing 21 is injected, which could short-circuit the temperature sensor 10. On the other side, the extension 15 allows easy access to the contact pin 13 when connecting the sensor lines 14 or the conductor bracket 17 during manufacture.

Advantageously, the temperature sensors 10 may each have a separate power supply via their own sensor line 14. In this way, critical heat generation at a contact pin 3 can be better recognized, for example, caused by an increased contact resistance. Alternatively, the temperature sensors 10 may be connected with each other in series or in parallel, and may have a common sensor neutral conductor 16 and a common voltage supply.

Advantageously, a may hold the temperature sensor 10 in the at least one receptacle 9 spaced from the carrier plate 2. By this spacing of the temperature sensor 10, the length of a creepage distance from the temperature sensor 10 to the contact pins 3 through the contact surface 23 between the insert 7 and the carrier plate 2 can be increased, which also increases the breakdown voltage. The fixation also serves to prevent the temperature sensor 10 from being pressed in the direction of the carrier plate 2 by the injection-molding compound during the injection of the injection-molded casing 21.

The fixation can, advantageously, be accomplished indirectly by way of at least one contact pin 13. As a result, the temperature sensor 10 is held by its contact pin 13 on the stop in the receptacle 9. The contact pin 13 can in this case in particular be affixed outside of the receptacle 9.

In the plug 1, as shown in FIGS. 1 to 11, the fixation is implemented in that the conductor bracket 17 rests on the extensions at the lateral contact surface 23.

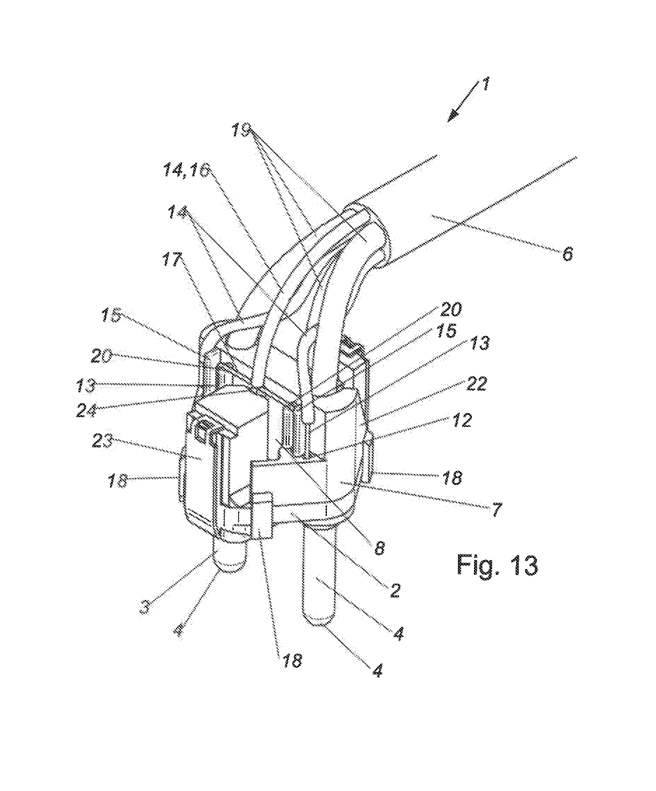

Advantageously, the fixation can be implemented in that at least one contact pin 13 or a contact pin 13 extending the conductor of the exit openings 12 projecting from the exit openings 12 of the at least one receptacle 9 is angled about a support 20 formed on the insert 7. Under a force pressing the temperature sensor 10 from the exit openings 12, the contact pin 13 or the conductor extending the contact pin 13 is pressed against the support 20, thereby retaining the temperature sensor 10 reliably at its position. Due to the support 20 being formed on the insert 7, this is accomplished regardless of the actual configuration of the rest of the plug, thereby fixing the position even with plug types lacking a lateral contact surface 23. This is particularly advantageous in the formation of a conductor bracket 17, since a tensile force applied to a contact pin 13 in any direction is counteracted by the two temperature sensors 10 bearing against the supports. Such an embodiment is shown in FIGS. 12 and 13.

The support 20 may in this case be part of a further extension extending in particular parallel to the extension 15.

Furthermore, a soldering support 24 arranged in particular between the supports 20 may be formed on the partition wall 8. Here, the soldering location may be placed between the conductor bracket 17 and the sensor neutral conductor 16 on the soldering support 24 formed as a projection, with the soldering support 24 ensuring reliable positioning of the conductor bracket 17 for soldering the sensor neutral conductor 16.

Although not shown in detail, the fixation can be implemented by angling at least one contact pin 13 projecting from the exit openings 12 of the at least one receptacle 9 directly after the exit opening 12. The angled contact pin 13 can then be angled a second time to form an S-shape.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A plug comprising:
a carrier plate;
at least two contact pins affixed to the carrier plate, each contact pin having a free end and a terminal end;
a cable including electrical conductors which are connected with the terminal ends of the contact pins;
an insert having a partition wall and a receptacle disposed on a side of the partition wall facing away from the contact pins, said insert being affixed on the carrier plate; and
a temperature sensor arranged in the receptacle.

2. The plug of claim 1, wherein the temperature sensor is in thermal contact with an inner wall of the receptacle by way of an interference fit.

3. The plug of claim 1, wherein the receptacle comprises an insertion opening disposed on a side of the insert facing the carrier plate, said carrier plate configured to close the insertion opening.

4. The plug of claim 3, wherein the receptacle has on a side facing away from the insertion opening exit openings for two electrical contact pins of the temperature sensor and a stop for the temperature sensor.

5. The plug of claim 1, further comprising a fixation configured to retain the temperature sensor in the receptacle with a spacing from the carrier plate.

6. The plug of claim 5, further comprising a support formed on the insert, said fixation being implemented by bending after the exit opening at least one contact pin which projects from the exit opening of the receptacle about the support or by bending after the exit opening a conductor which extends the at least one contact pin about the support.

7. The plug of claim 1, further comprising an extension formed on the partition wall at the receptacle between two sensor lines connected to the temperature sensor.

8. The plug of claim 1, wherein the insert includes two of said receptacle for association with the contact pins respectively and arrangement of two of said temperature sensor respectively.

9. The plug of claim 1, further comprising:
a sensor neutral conductor; and
a conductor bracket connected to the sensor neutral conductor, said conductor bracket being electrically connected to at least two of said temperature sensor.

10. The plug of claim 1, further comprising a clip connection affixing the insert on the carrier plate.

11. A method for producing a plug, said method comprising:
affixing at least two contact pins on a carrier plate;
connecting electrical conductors of a cable to terminal ends of the at least two contact pins;
arranging a temperature sensor in a receptacle on one side in a partition wall of an insert which side faces away from the contact pins; and
affixing the insert on the carrier plate.

12. The method of claim 11, wherein the temperature sensor is arranged in the receptacle by inserting the temperature sensor into the receptacle through an insertion opening, and further comprising closing off the insertion opening by the carrier plate when the insert is affixed on the carrier plate.
